(19) United States
(12) Patent Application Publication
(10) Pub. No.: US 2018/0246635 A1
(43) Pub. Date: Aug. 30, 2018

(54) GENERATING USER INTERFACES COMBINING FOREGROUND AND BACKGROUND OF AN IMAGE WITH USER INTERFACE ELEMENTS

(71) Applicant: Microsoft Technology Licensing, LLC, Redmond, WA (US)

(72) Inventors: Matthias Baer, Seattle, WA (US); Remi Wesley Ogundokun, Seattle, WA (US)

(21) Appl. No.: 15/441,320

(22) Filed: Feb. 24, 2017

(51) Int. Cl. G06F 3/0484; G06F 3/0488

(52) U.S. Cl. CPC G06F 3/04845; G06F 3/0488

(57) ABSTRACT

Information about foreground and background regions in an image are used in a graphical user interface to combine the image with one or more user interface elements. The combination of the image and user interface element can change interactively. The combined image and user interface element can provide a sense of depth to the user interface. A server computer can include an image library to store pixel data for an image and metadata describing foreground and background regions of an image. A user interface object can represent the combination of an image and a user interface element by including references to the foreground and background regions of an image, and a reference to one or more user interface elements, and data specifying a different z-ordering for each of the foreground region, the background region and the user interface element, and properties to be applied to the user interface element.

### BACKGROUND

A challenge with designing a graphical user interface for a computer is providing visual cues that direct a user's focus and attention to elements of the graphical user interface. Such elements may convey information or may represent controls that can be manipulated by a user. The graphical user interface is designed to direct a user's focus to the information or controls to help the user interact with the computer.

A computer typically generates a graphical user interface as a combination of layers of image data. Each layer typically is comprised of one or more elements, such as text, graphics and controls, overlaid on a background. The computer typically combines the layers as a stack, with one of the layers on top, one of the layers on the bottom, and presents the combined layers on a background. Typically, the bottom layer is overlaid on the background, and each subsequent layer is overlaid on the combination of lower layers. In some instances, a layer may have some “transparent” portions through which other layers can be seen.

### SUMMARY

This Summary is provided to introduce a selection of concepts in a simplified form that are further described below in the Detailed Description. This Summary is intended neither to identify key or essential features, nor to limit the scope, of the claimed subject matter.

A graphical user interface of a computer uses information about a foreground region and a background region in an image to combine one or more user interface elements, such as text or a control, with the foreground and background regions. Such a combination can include interleaving one or more user interface elements between the foreground and the background regions of the image. The combination of the image and the other user interface element(s) can change interactively in response to inputs, such as inputs from the environment, the computer system and/or the user. By interleaving a user interface element between the foreground and background regions of an image, a sense of depth can be provided by the user interface. With this appearance of depth, by interactively changing the combination of the image and user interface element in response to inputs, a sense of movement can be provided by the user interface. The sense of depth and movement can be used to direct focus to different regions or elements of the graphical user interface. The depth or movement associated with a user interface interaction can be conceptually related to the user interface interaction, such as lifting, pushing, hiding and sliding user interface elements within the graphical user interface.

In some implementations, a server computer includes an image library in which image data includes pixel data for an image and metadata describing foreground and background regions of the image. The server computer can include an image processor that processes images stored in the image library to output the metadata for the images. Such a server computer eliminates processing on client computers to generate such metadata.

In some implementations, the graphical user interface uses a data structure, herein called a user interface object, to represent the combination of the image and the user interface element. The user interface object includes at least a reference to the foreground region of the image data, a reference to the background region of the image data, and a reference to the user interface element. The user interface object further includes data specifying a different z-order for each of the foreground region, the background region and the user interface element. The user interface object also specifies properties to be applied to the user interface element, wherein the properties include at least data specifying a position in two dimensions, such as an x-coordinate and y-coordinate with respect to the image data. Such a position can be defined relative to the foreground region, background region or the pixel data of the image. Such a data structure allows the combination and animation of the image and user interface element in response to interaction with the computer system to be easily specified by setting and changing properties in the user interface object.

In the following description, reference is made to the accompanying drawings which form a part hereof, and in which are shown, by way of illustration, specific example implementations. Other implementations may be made without departing from the scope of the disclosure.

### BRIEF DESCRIPTION OF THE DRAWINGS

FIGS. 1 and 2 are illustrations of an example graphical user interface that combines a foreground and background of an image with another user interface element.

FIG. 3 is a data flow diagram of an illustrative example implementation of a graphical user interface that combines an image with another user interface element.

FIG. 4 is a data flow diagram of an illustrative example implementation of a graphical user interface that uses images retrieved from a server computer.

FIG. 5 is an illustration of an example data structure for a user interface object that specifies a combination of an image with another user interface element.

FIG. 6 is a flowchart of operation of an example implementation of generating a user interface object such as in FIG. 5.

FIG. 7 is a flowchart of operation of an example implementation of generating display data for a graphical user interface using a user interface object.

FIG. 8 is a flowchart of operation of an example implementation of interactively updating a graphical user interface including a user interface element that combines an image with another user interface element.

FIG. 9 is a block diagram of an example computer.

### DETAILED DESCRIPTION

A graphical user interface of a computer uses information about a foreground region and a background region in an image to combine one or more user interface elements, such as text or a control, with the foreground and background regions. Such a combination can include interleaving one or more user interface elements between the foreground and the background regions of the image. The combination of the image and the other user interface element(s) can change interactively in response to inputs, such as inputs from the environment, the computer system and/or a user. By interleaving a user interface element between the foreground and background regions of an image, a sense of depth can be provided by the user interface. With this appearance of depth, by interactively changing the combination of the image and user interface element in response to inputs, a sense of movement can be provided by the user interface. The sense of depth and movement can be used to direct focus to different regions or elements of the graphical user interface. The depth or movement associated with a user interface interaction can be conceptually related to the user interface interaction, such as lifting, pushing, hiding and sliding user interface elements within the graphical user interface.

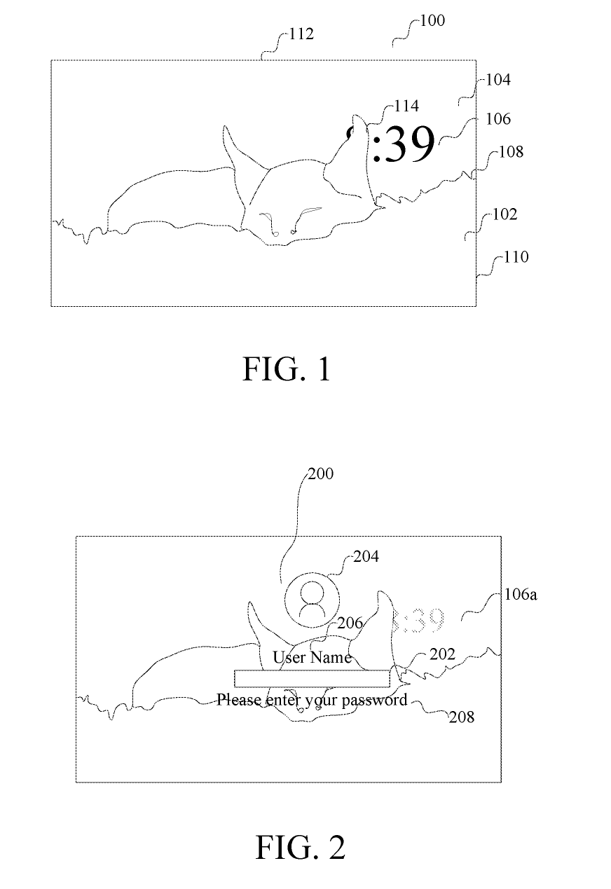

FIGS. 1 and 2 are illustrations of an example graphical user interface for a computer. The graphical user interface combines a foreground region and a background region of an image with at least one other user interface element. In at least one state of the graphical user interface, at least one user interface element is interleaved between the foreground region and the background region of the image.

In FIG. 1, an image 100 is defined by pixel data for the image. Metadata associated with the pixel data defines a foreground region 102 and a background region 104 in the image. Pixel data generated by a computer to display a user interface element 106 is combined with pixel data from the image 100. In this example, the graphical user interface is a “lock screen” presented by an operating system of the computer, while the computer is in a locked state. In this example, the graphical user interface includes an image 100, which in this example is a “wallpaper” image which fills the display screen. The foreground region 102 is a part of the wallpaper image. In this instance the foreground region is a lower half of the wallpaper image, which includes a cat lying in a grass field. The background region 104 is the remaining part of the wallpaper image. In this example, the background region is the upper half of the wallpaper image, which can be the sky. A curve 108 along the top of the grass and then the top of the cat, is illustrated in FIG. 1 to delineate a boundary or edge between the foreground image 102 and the background image 104, but is not intended to illustrate a visible line in the pixel data of the image 100 or pixel data of the combined image of the graphical user interface.

Any data that can be used to specify, for each pixel in the pixel data, whether that pixel is in the foreground region or the background region, can be used as metadata that defines the foreground and background regions. There may be multiple foreground regions.

For example, the foreground region can be defined by one or more shapes, defined by a set of lines and/or curves associated with the image. Similarly, the background region can be defined by one or more shapes associated with the image.

Data can be stored to define the foreground region, with the background region being defined as any pixel outside of the foreground region. Similarly, data can be stored to define the background region, with the foreground region being defined as any pixel outside of the background region.

As another example, an alpha channel, or mask image, associated with the image can define the foreground and background regions of the image. An alpha channel or mask image is data that represents, for each pixel, the region in which the pixel resides. For example, a value of 0 or 1 for each pixel can indicate whether a pixel is in the background region or the foreground region. A set of such values can be considered a binary image. Three or more values can be used to represent three or more layers.

As another example, the pixel data within each region can be stored as separate pixel data. For example, pixel data for the foreground region can be stored as one image, where pixels not in the foreground region are represented by a predetermined value. Similarly, pixel data for the background region can be stored as another image, where pixels not in the background region are represented by a predetermined value.

In this example, the foreground region is defined by the boundaries 110 of the image and the curve 108, and the background region is defined by the boundaries 112 of the image and the curve 108.

The graphical user interface also includes a user interface element 106. In the example shown in FIG. 1, a single user interface element is shown, which is a set of alphanumeric symbols representing a clock showing the time “8:39”. The user interface element can be any type of user interface object typically found in a graphical user interface, such as an object that displays alphanumeric text, symbols and/or graphics, or an object that is a control which is responsive to user input. For example, the user interface object can be a modal dialog box, a call-out interface, or small pop-up window, a text box, a menu, or other object. The graphical user interface can include multiple separate user interface elements, each of which can have a separate z-order relative to the foreground and background regions of the image and a separate position in two dimensions, such as an x-coordinate and a y-coordinate, relative to the image. The term “z-order” refers to the ordering of the foreground region, background region and user interface elements along a z-axis, where the z-axis is perpendicular to a plane defined by the image. The z-order can be defined as the cardinal order of each element, or can be defined by a coordinate along the z-axis, also called a z-position or z-coordinate.

Each of the foreground region 102, background region 104 and the user interface element 106 is processed as a separate layer to generate the display data for the graphical user interface. Each such layer has a z-order relative to the other layers. In addition, the user interface element 106 has a position in two-dimensions relative to the image 100. In FIG. 1, the user interface element 106 can have a z-order which, when the layers are combined, places the user interface element on top of the background region, but behind the foreground region. For example, the background region can have a z-order of 0; the foreground region can have a z-order of 2, and the user interface element can have a z-order of 1. In this case, a portion of the “8” in “8:39” is occluded, at 114, and appears to be obscured by the foreground region (the ear of the cat). Such occlusion of the user interface element by the foreground region gives a sense of depth in the image. When the z-orders of the foreground region and the user interface element are swapped, the user interface element 106 would appear on top of both the foreground region and the background region.

Turning now to FIG. 2, an additional user interface element 200 is shown in combination with the image 100 and user interface element 106 from FIG. 1. In this example, the user interface element 106 also is smaller than as shown in FIG. 1, and blurred, and is labeled as 106a. The blurring and shrinking of this user interface element de-emphasizes it. In this example, the additional user interface element 200 is a login control box, which includes a text box 202 for entering a password, an identification of the user, such as a picture 204 or text 206 representing a user name, and text prompt 208, such as “Please enter your password”. As shown in FIG. 2, an additional user interface element 200, such as a login control box, may include several distinct elements, but can be treated as a single user interface element for the purposes of its combination with the image 100. In other words, display data can be generated to represent the login control box 200, and this display data for the login control box can be treated as a single layer when the login control box combined with the foreground and background of the image and the other user interface element 106.

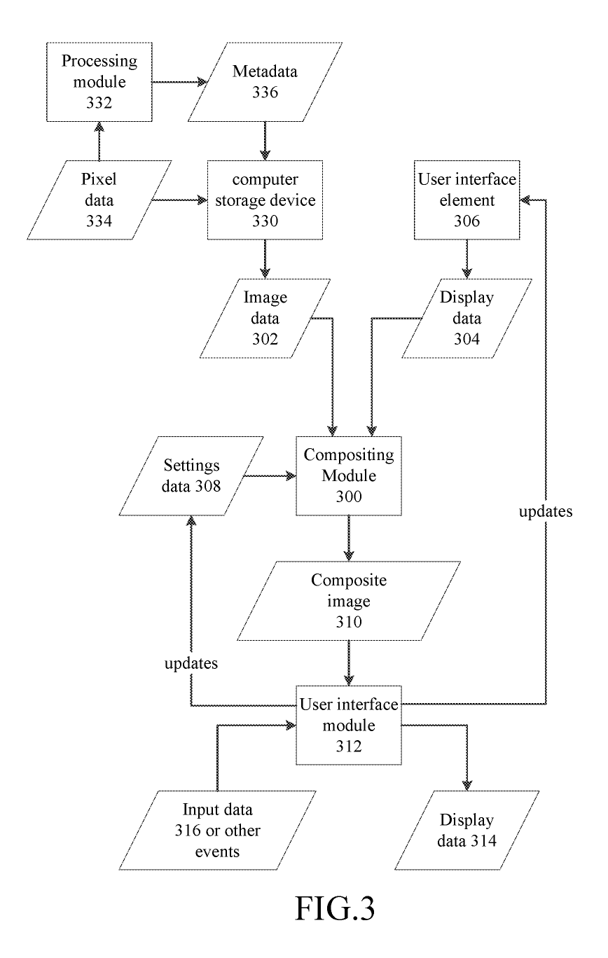

Turning now to FIG. 3, a data flow diagram of an illustrative example implementation of a computer that generates such a graphical user interface will now be described. This is an illustrative example implementation; many other implementations are possible.

The computer includes a compositing module 300 which receives image data 302 for an image and display data 304 for a user interface element 306. The image data 302 for an image includes pixel data for the image and metadata indicative of the foreground region and background region of the image. The display data 304 includes at least pixel data generated for the user interface element. Settings data 308 include at least a relative z-order of the foreground region, background region and user interface element and relative position data indicating how the display data 304 for the user interface element is positioned relative to the pixel data for the image data 302.

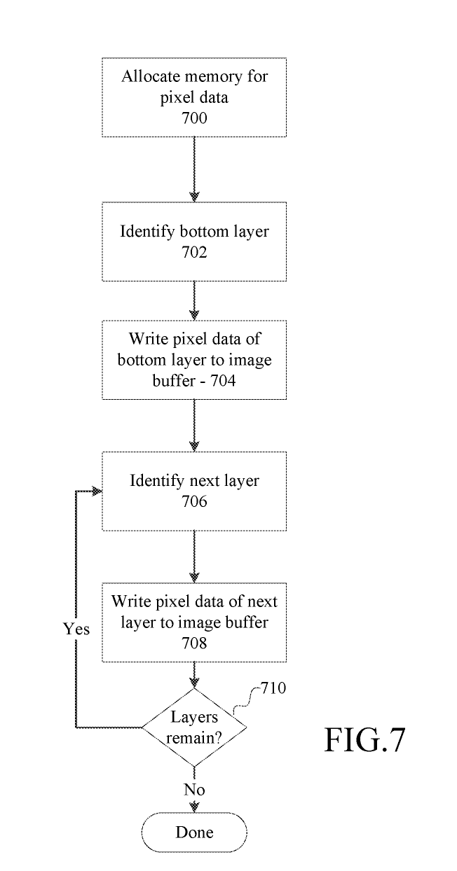

The compositing module processes pixel data for the image data 302 and display data 304 based on at least the metadata indicative of the foreground region and the background region and the settings 306 to generate a composite image 310 for the graphical user interface. An example implementation of such processing will be described in more detail below in connection with FIG. 7.

The composite image 310 is provided to a user interface module 312, which provides display data 314 to an output device and which receives events, such as input data 316, from one or more input devices. In response to the input data 316, the user interface module may update the settings data 308 or the user interface element 306, which in turn can result in a change to the composite image 310. An updated composite image 310 is generated and displayed for the graphical user interface. The user interface module also may make such changes in response to other events (as indicated at 316).

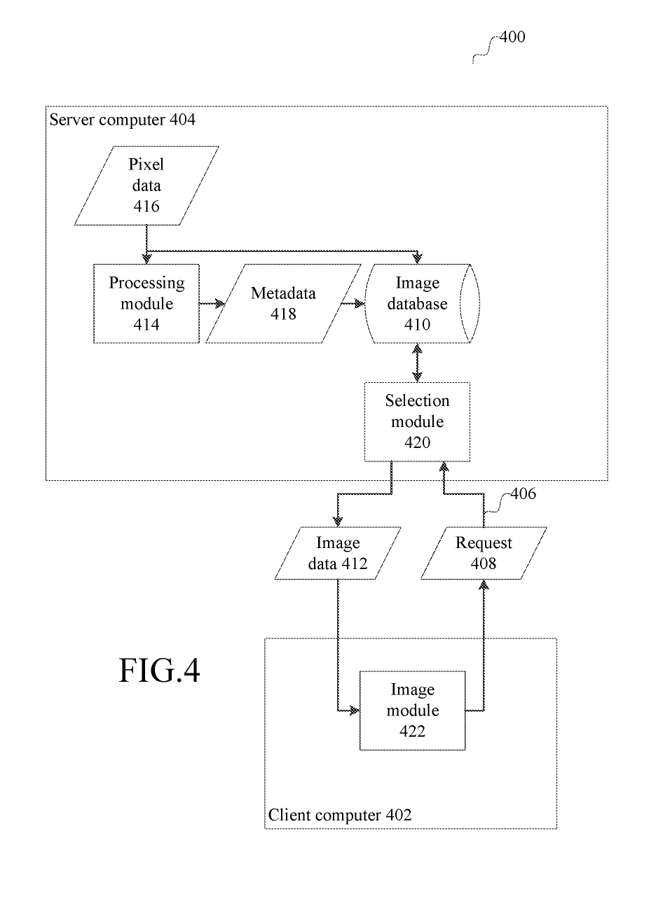

FIG. 3 also shows an example implementation of a source for the image data 302. An illustrative example implementation of a kind of source of image data is described in more detail in connection with FIG. 4. In FIG. 3, image data 302 is retrieved from a computer storage device 330. An image processing module 332 receives pixel data 334 for an image and outputs metadata 336 for the image indicating foreground and background regions in the image. The pixel data and metadata are stored in the computer storage device 330. Thus, when image data 302 is accessed from the computer storage device 330, the metadata for the foreground and background regions have already been computed. In some implementations, an image can be processed at the time the image is accessed for use in a graphical user interface, to identify foreground and background regions; however, such an implementation can introduce a delay in generating the graphical user interface using that image.

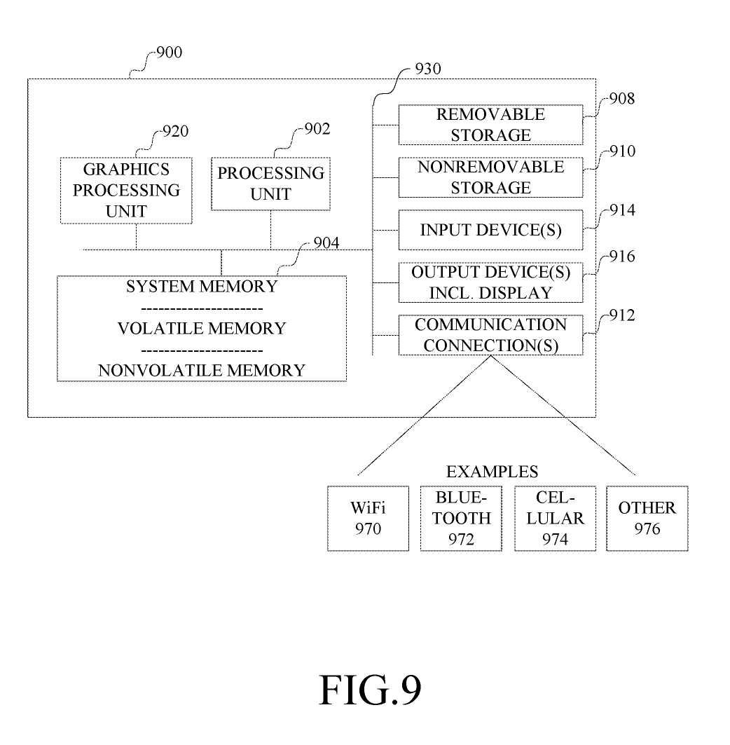

FIG. 4 is a data flow diagram of an illustrative example implementation of a computer system 400 including a client computer 402 with a graphical user interface that uses images retrieved from a server computer 404 over a computer network 406. The server computer is shown in FIG. 4 as a single server computer, but can be implemented using multiple server computers. Each server computer can be implemented using one or more general purpose computers, such as described in FIG. 9, where each general-purpose computer is configured as a server computer.

The computer network can be any computer network supporting interaction between the end user computers and the shared storage system, such as a local area network or a wide area network, whether private and/or publicly accessible, and can include wired and/or wireless connectivity. The computer network can be implemented using any kind of available network communication protocols, including but not limited to Ethernet and TCP/IP.

Multiple different client computers 402 (not all shown), can access the server computer 404 over the computer network 406. Each client computer 402, which can be implemented using a general-purpose computer system such as shown in FIG. 9, includes an application that implements the graphical user interface in a manner such as described in connection with FIG. 3. Examples of such a computer include, but are not limited to, a tablet computer, a slate computer, a notebook computer, a desktop computer, a virtual desktop computer hosted on a server computer, a handheld computer, game console, a mobile phone including a computer and applications, a virtual or augmented reality device including a computer and applications, or wearable device including a computer and applications.

In implementations incorporating a server computer 404, a client computer includes an image module 422 which transmits a request 408 over the computer network, and the server computer receives and processes the request 408. The request includes data indicating that the client computer is requesting an image from an image database 410. The request may include other data, such as information about a user of the client computer, such as a user identifier, and/or information about the client computer or its applications, and/or a specification for the image data, such as size in pixels or other characteristic of the image. For example, the request may identify a specific image from the database by way of an identifier for the image, or may be an instruction to the server computer image to select an image from the database. The image module 422 can be a service of the operating system of the client computer, through which an application can request an image, or can be implemented as part of a computer program, such as an application or process of the operating system, to access images from the server computer for that computer program.

In response to the request, the server computer accesses the image database 410 to retrieve an image. The image data 412 for the retrieved image is transmitted to image module 422 of the client computer 402 over the computer network 406. In such implementations, the image data 412 includes pixel data for the image and metadata indicating the foreground and background regions of the image. There are several different possible formats which can be used for the image data 412, to represent the metadata and associate the metadata with the pixel data, as described above. The client computer receives and processes the image data for use in its graphical user interface, such as shown in FIG. 3.

The server computer 404 can include one or more processing modules, i.e., computer programs that process the images stored in the image database 410. For example, a processing module 414 receives pixel data 416 for an image and outputs metadata 418 identifying foreground and background regions of the image. There are several kinds of image processing which can be used by a processing module 414 to identify foreground and background regions of an image, such as by keying, image segmentation, boundary and edge detection, watershed transforms, and the like. In addition, the foreground and background regions can be identified in response to user input indicating which pixels are in the foreground and background regions.

A selection module 420 receives data indicative of a request 408 for an image and outputs image data 412 selected from the image database 410. In an example implementation, the selection module can perform a database retrieval operation given an identifier for an image from the request 408. As another example, the selection module can perform a query on an index of the image database to select an image using one or more items of information from the request 408. The selection module can perform a random or deterministic selection from among a set of images identified from such a query.

In some implementations, the client computer can prefetch and store a set of images for use in the graphical user interface. In some implementations, the client computer can transmit images to the server computer for processing to identify the foreground and background regions, and the server computer can return metadata for the image. In some implementations, the client computer can process an image once and store image data with metadata indicating the foreground and background regions. For example, when a user selects an image for use in a graphical user interface, such as for a “desktop wallpaper” or lock screen image, the image can be processed at the time the image is selected, by either the server computer or the client computer, to identify foreground and background images.

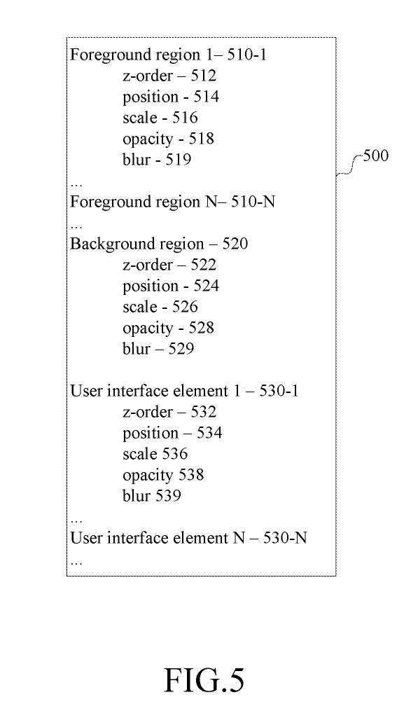

Turning now to FIG. 5, further details of an example implementation for a user interface on a client computer will now be described. FIG. 5 is an illustration of an example data structure for a user interface object used to combine an image with one or more user interface elements, which can be used in an application on the client computer. The user interface object 500 includes data representing at least one foreground region 510, data representing a background region 520 and data representing at least one user interface element 530. There can be a plurality of foreground regions; thus FIG. 5 indicates foreground regions 510-1 to 510-N. Similarly, there can be a plurality of user interface elements; thus FIG. 5 indicates user interface elements 530-1 to 530-N.

The data representing the foreground region includes at least a z-order 512 for the foreground region with respect to the other layers defined in the user interface object 500. This data also can include values for other properties of the layer, such as position 514 relative to the background region, relative to the image or relative to a coordinate system defined for the display data of the user interface object, such as an x-coordinate and a y-coordinate. A scale property 516 indicates how much the pixel data for the foreground is scaled when combined with the user interface element and background, if at all. A default value can be no scaling. An opacity property 518 indicates how opaque or transparent the foreground is when combined with the image. A default value can be no transparency. A blur property 519 indicates how much blurring is applied to the foreground pixel data when combining it with the background and the user interface element. The blur property can be implemented as a parameter to a blur function. A default value can be no blurring.

The data representing the background region includes at least a z-order 522 for the background region with respect to the other layers defined in the user interface object. This value is typically zero, and less than the z-order of the foreground region. This data also can include values for other properties of the layer, such as its position 524 with respect to a coordinate system defined for the display data of the user interface object, such as an x-coordinate and a y-coordinate. A scale property 526 indicates how much the pixel data for the background is scaled when combined with the user interface element and foreground, if at all. A default value can be no scaling. An opacity property 528 indicates how opaque or transparent the background is when combined with the foreground and user interface element. A default value can be no transparency. A blur property 529 indicates how much blurring is applied to the background pixel data when combining it with the foreground and the user interface element. The blur property can be implemented as a parameter to a blur function. A default value can be no blurring.

The data representing a user interface element includes at least a z-order 532 for that element with respect to the other layers defined in the user interface object. This data also can include values for other properties of the user interface element, such as: its position 534 relative to the image, or to the background region, or to the foreground region, or to a coordinate system defined for the display data of the user interface object, such as an x-coordinate and a y-coordinate. A scale property 536 indicates how much the display data for the user interface element should be scaled when combined with the image. A default value can be no scaling. An opacity property 538 indicates how opaque or transparent the user interface element should be when combined with the image. A default value can be no transparency. A blur property 539 indicates how much blurring is applied when combining display data for the user interface element with the image, and can be implemented as a parameter for a blur function. A default value can be no blurring.

The data structure shown in FIG. 5 is merely an illustrative example. A suitable data structure can include more properties for an image region or for a user interface element. For example, properties such as z-position, rotation, or other spatial or color transformations can be applied. For example, brightness of an image region or user interface element can be modified. A suitable data structure can include less properties for an image region or for a user interface element, so long as a relative z-ordering of the foreground region, background region and at least one user interface element can be determined and updated, such that the user interface element can be interleaved between the foreground region and the background region.

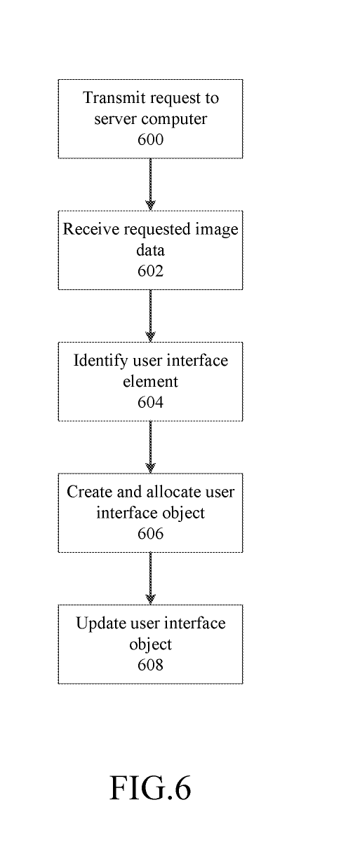

A computer program implementing such a graphical user interface can include an object definition or other form of representation of a data structure, such as shown in FIG. 5, to define a user interface object as a combination of one or more user interface elements and an image. Other computer program instructions can be associated with this user interface object to perform operations such as generating and presenting display data for the graphical user interface, and updating the properties of the user interface object in response to user input, system input, sensor or other device input, or other system state. Some example operations will now be described in connection with FIGS. 6 through 8.

FIG. 6 is a flowchart of operation of an example implementation of generating a user interface object such as in FIG. 5.

The process of FIG. 6 initializes the user interface object for a graphical user interface. As a result of this process, performed by executing a computer program on a computer, the user interface object is allocated in memory of the computer, with values stored for the properties of the foreground region, background region and user interface element. The steps of FIG. 6 need not be performed in the order described; in some instances, steps may be performed as the same action, such as creating a data structure with specific values. This initialization may include the computer transmitting 600 a request to a server computer for image data of an image. The computer then receives 602 the requested image data, including pixel data for the image and data identifying the foreground and background regions of the image. This initialization also can include initializing or identifying 604 one or more user interface elements for which display data is incorporated into this user interface object. A data structure representing the user interface object is created and allocated 606 in memory. This user interface object is updated 608 to include values for the properties of the foreground region, background region and the user interface element, to the extent those values are not set as part of the creation and allocation step.

FIG. 7 is a flowchart of operation of an example implementation of generating display data for a user interface object such as in FIG. 5. This display data can be combined with yet other display data and displayed as part of a graphical user interface of the computer. In this process, the computer allocates 700 memory to store pixel data for the display data representing the user interface object, herein called the image buffer. Such allocation may be performed once, and need not be performed each time the user interface object is rendered. The computer identifies 702 the bottom layer among the layers included in the user interface object based on the z-order data in the user interface object. For example, the bottom layer may be the background region of the image. As another example, the computer can search the properties of the different layers to identify the layer with the z-order value representing the bottom layer. The pixel data corresponding to the bottom layer is written 704 to the image buffer. The next layer is then identified 706. Pixel data for the next layer is written 708 to the image buffer. This process of steps 706 and 708 is then repeated for each layer until all layers are processed, as indicated at 710.

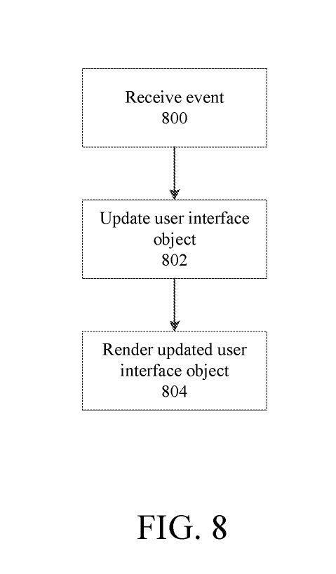

FIG. 8 is a flowchart of operation of an example implementation of interactively updating a graphical user interface including a user interface element that combines an image with another user interface element.

In general, interactive changes in a graphical user interface for a computer program occur in response to events processed by the computer for which the computer program is notified, and for which the computer program is implemented to process. Generally, a programmer specifies in a computer program which events cause changes in the graphical user interface, and what those changes are.

Thus, in FIG. 8, the computer program receives 800 an indication of an event processed by the computer. Details about the event, such as a type of the event, etc., are received. Given the details about the event, the user interface object (such as in FIG. 5) may be updated 802 by the computer program. After updating the user interface object, the user interface object is rendered 804 (i.e., display data for the object is generated), and the display of the user interface object in the graphical user interface is updated 806.

A wide variety of possible changes can occur to the user interface object in response to events processed by the computer, such as changes in state, inputs from a user, inputs from other computers, inputs from sensors, changes in the environment as detected by sensors, notifications or events or interrupts from within the computer or from other computers, or the passage of time as determined by a timer. Such changes may occur interactively in response to a user's interaction with the computer.

Such changes can be implemented gradually by animation over a period of time. For example, given an initial set of properties, and the updated set of properties, a period of time and a number of samples to be generated over that period of time can be defined. The range of values between an initial value of a property and a final value of that property can be interpolated and sampled to generate intermediate properties. The display data for the user interface object can be generated using the intermediate properties for each of the number of samples of the period of time to generate an animated change to the user interface object.

The depth or movement associated with a user interface interaction can be conceptually related to the user interface interaction, such as lifting, pushing, hiding and sliding user interface elements within the graphical user interface.

For example, in response to an input representing a gesture by a user with respect to the user interface element, when that user interface element is not a top layer in the user interface object, can result in that user interface element being moved to the top layer. Other properties of the user interface element could be changed, such as its scale, opacity or blur. For example, when the user interface element is on the top layer, it may be at its full scale, with no opacity and no blur. However, when that user interface is not in focus, it may be interleaved between the foreground and the background, slightly blurred, slightly transparent and scaled to be slightly smaller. The transition from presenting the user interface element at a lower layer to presenting the user interface element at the top layer can be animated over a period of time. As a result, the change in properties of the user interface element make the user interface element appear to be brought forward and into focus.

As another example, in response to an input representing a notification, a user interface element corresponding to the notification can be added to the user interface object as a top layer. Another user interface element in the user interface object can be moved to be between the foreground layer and background layer of the image. The other user interface element also can have other properties changed, such as its scale, opacity and blur. For example, the user interface element can be reduced in size, made partially transparent, and slightly blurred. Such changes can be effected gradually through an animation over time. As a result, the change in properties of the user interface make the notification come into focus and the other user interface element appears pushed away and out of focus.

As another example, in response to an input representing the computer detecting presence of a user near the computer, a user interface element corresponding to a login prompt can be added to the user interface object as a top layer. Another user interface element in the user interface object can be moved to be between the foreground layer and background layer of the image. The other user interface element also can have other properties changed, such as its scale, opacity and blur. For example, the user interface element can be reduced in size, made partially transparent, and slightly blurred.

Having now described an example implementation, FIG. 9 illustrates an example of a computer with which components of the computer system of the foregoing description can be implemented. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones including but not limited to “smart” phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 9, a computer 900 includes a processing system comprising at least one processing unit 902 and at least one memory 904. The processing unit 902 can include multiple processing devices; the memory 904 can include multiple memory devices. A processing unit 902 comprises a processor which is logic circuitry which responds to and processes instructions to provide the functions of the computer. A processing device can include one or more processing cores (not shown) that are multiple processors within the same logic circuitry that can operate independently of each other. Generally, one of the processing units in the computer is designated as a primary processor, typically called the central processing unit (CPU). One or more additional co-processing units 920, such as a graphics processing unit (GPU), also can be present in the computer. A co-processing unit comprises a processor that performs operations that supplement the central processing unit, such as but not limited to graphics operations and signal processing operations.

The memory 904 may include volatile computer storage devices (such as dynamic random access memory (DRAM) or other random access memory device), and non-volatile computer storage devices (such as a read-only memory, flash memory, and the like) or some combination of the two. A nonvolatile computer storage device is a computer storage device whose contents are not lost when power is removed. Other computer storage devices, such as dedicated memory or registers, also can be present in the one or more processors. The computer 900 can include additional computer storage devices (whether removable or non-removable) such as, but not limited to, magnetically-recorded or optically-recorded disks or tape. Such additional computer storage devices are illustrated in FIG. 1 by removable storage device 908 and non-removable storage device 910. Such computer storage devices 908 and 910 typically are nonvolatile storage devices. The various components in FIG. 9 are generally interconnected by an interconnection mechanism, such as one or more buses 930.

A computer storage device is any device in which data can be stored in and retrieved from addressable physical storage locations by the computer by changing state of the device at the addressable physical storage location. A computer storage device thus can be a volatile or nonvolatile memory, or a removable or non-removable storage device. Memory 904, removable storage 908 and non-removable storage 910 are all examples of computer storage devices. Some examples of computer storage devices are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage devices and communication media are distinct categories, and both are distinct from signals propagating over communication media.

Computer 900 may also include communications connection(s) 912 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals.

Communications connections 912 are network interface devices, such as a wired network interface, wireless network interface, radio frequency transceiver, e.g., WiFi 970, cellular 974, long term evolution (LTE) or Bluetooth 972, etc., transceivers, navigation transceivers, e.g., global positioning system (GPS) or Global Navigation Satellite System (GLONASS), etc., transceivers, and other network interface devices 976, e.g., Ethernet, etc., or other device, that interface with communication media to transmit data over and receive data from signal propagated over the communication media.

The computer 900 may have various input device(s) 914 such as a pointer device, keyboard, touch-based input device, pen, camera, microphone, sensors, such as accelerometers, thermometers, light sensors and the like, and so on. The computer 900 may have various output device(s) 916 such as a display, speakers, and so on. Such devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various computer storage devices 908 and 910, communication connections 912, output devices 916 and input devices 914 can be integrated within a housing with the rest of the computer, or can be connected through various input/output interface devices on the computer, in which case the reference numbers 908, 910, 912, 914 and 916 can indicate either the interface for connection to a device or the device itself.

A computer generally includes an operating system, which is a computer program that, when executed, manages access, by other applications running on the computer, to the various resources of the computer. There may be multiple applications. The various resources include the memory, storage, input devices and output devices, such as display devices and input devices as shown in FIG. 9. To manage access to data stored in nonvolatile computer storage devices, the computer also generally includes a file system which maintains files of data. A file is a named logical construct which is defined and implemented by the file system to map a name and a sequence of logical records of data to the addressable physical locations on the computer storage device. Thus, the file system hides the physical locations of data from applications running on the computer, allowing applications to access data in a file using the name of the file and commands defined by the file system A file system generally provides at least basic file operations such as creating a file, opening a file; writing a file or its attributes, reading a file or its attributes, and closing a file.

The various modules, tools, or applications, and data structures and flowcharts of FIGS. 1-8, as well as any operating system, file system and applications on a computer in FIG. 9, can be implemented using one or more processing units of one or more computers with one or more computer programs processed by the one or more processing units.

A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data, or configure the computer to implement various components, modules or data structures.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Accordingly, in one aspect, a computer comprises a processing system including at least one processing unit and at least one computer storage device, an input receiving user input from an input device connected to the computer, an output providing display data to a display connected to the computer, and a network interface device connecting the computer to a computer network and managing communication with a server computer connected to the computer network. The computer storage device stores computer program instructions that, when executed by the processing system, configure the computer. The configured computer includes an image module operative to retrieve image data for an image from the server computer, the image data including pixel data for the image and metadata indicating at least a foreground region in the image and a background region in the image, and an output to store the image data in the computer storage device. A user interface element has an output providing display data for a user interface element to the computer storage device. A compositing module is operative to access the display data for the user interface element and the image data and settings data from the computer storage device. The settings data include at least a relative z-order of the foreground region, background region and user interface element and properties of the user interface element. The properties include at least relative position data indicating how the display data for the user interface element is positioned relative to the pixel data for the image data. The compositing module combines the pixel data from the foreground region, the pixel data from the background region of the image, and display data for the user interface element, based on at least the settings data to output a composite image to the computer storage device. A user interface module is operative to output the composite image in a graphical interface to the output of the computer.

In another aspect, a computer comprises a processing system including at least one processing unit and at least one computer storage device, an input receiving user input from an input device connected to the computer, and an output providing display data to a display connected to the computer. The computer storage device stores computer program instructions that, when executed by the processing system, configure the computer. The configured computer includes a user interface element has an output providing display data for a user interface element to the computer storage device. The computer storage device further stores image data for an image, the image data including pixel data for the image and metadata indicating at least a foreground region in the image and a background region in the image. A compositing module is operative to access the display data for the user interface element and the image data from the computer storage device. The compositing module specifies a user interface object in the computer storage device comprising at least a reference to the foreground region of the image data, a reference to the background region of the image data, and a reference to the user interface element. The user interface object also includes settings data. The settings data include at least a relative z-order of the foreground region, background region and user interface element and properties of the user interface element. The properties include at least relative position data indicating how the display data for the user interface element is positioned relative to the pixel data for the image data. The compositing module combines the pixel data from the foreground region, the pixel data from the background region of the image, and display data for the user interface element, based on at least the settings data to output a composite image to the computer storage device. A user interface module is operative to output the composite image in a graphical interface to the output of the computer.

In another aspect, a computer includes means for retrieving image data for an image from a server computer, the image data including pixel data for the image and metadata indicating at least a foreground region in the image and a background region in the image. The computer also includes means for compositing the image with display data for a user interface element based on at least settings data. The settings data include at least a relative z-order of the foreground region, background region and user interface element and properties of the user interface element. The properties include at least relative position data indicating how the display data for the user interface element is positioned relative to the pixel data for the image data.

In another aspect, a computer includes means for specifying a user interface object. The user interface object includes at least a reference to the foreground region of the image data, a reference to the background region of the image data, and a reference to a user interface element. The user interface object also includes settings data. The settings data include at least a relative z-order of the foreground region, background region and user interface element and properties of the user interface element. The properties include at least relative position data indicating how the display data for the user interface element is positioned relative to the pixel data for the image data. The computer also includes means for compositing the image with display data for the user interface element based on at least the user interface object.

In another aspect, a computer implemented process includes retrieving image data for an image from a server computer, the image data including pixel data for the image and metadata indicating at least a foreground region in the image and a background region in the image. The process includes means for compositing the image with display data for a user interface element based on at least settings data. The settings data include at least a relative z-order of the foreground region, background region and user interface element and properties of the user interface element. The properties include at least relative position data indicating how the display data for the user interface element is positioned relative to the pixel data for the image data.

In another aspect, a computer implemented process includes specifying a user interface object. The user interface object includes at least a reference to the foreground region of the image data, a reference to the background region of the image data, and a reference to a user interface element. The user interface object also includes settings data. The settings data include at least a relative z-order of the foreground region, background region and user interface element and properties of the user interface element. The properties include at least relative position data indicating how the display data for the user interface element is positioned relative to the pixel data for the image data. The process also includes compositing the image with display data for the user interface element based on at least the user interface object.

In any of the foregoing aspects, the user interface module can be operative to change the z-order of the user interface element with respect to the foreground region and the background region in response to an event processed by the computer.

In any of the foregoing aspects, the user interface module can be operative to change the properties of the user interface element in response to an event processed by the computer.

In any of the foregoing aspects, properties of the user interface element can include one or more of position, a scale property, an opacity property, and/or a blur property.

In any of the foregoing aspects, a foreground region and/or the background region also may have properties, such as a position, a scale property, an opacity property, and/or a blur property. The user interface module can be operative to change the properties of a foreground region and/or the background region, in addition to or instead of the user interface element, in response to events processed by the computer.

In another aspect, an article of manufacture includes at least one computer storage medium, and computer program instructions stored on the at least one computer storage medium. The computer program instructions, when processed by a processing system of a computer, the processing system comprising one or more processing units and storage, configures the computer as set forth in any of the foregoing aspects and/or performs a process as set forth in any of the foregoing aspects.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

It should be understood that the subject matter defined in the appended claims is not necessarily limited to the specific implementations described above. The specific implementations described above are disclosed as examples only.

What is claimed is:

1. A computer comprising:
a processing system comprising:
at least one processing unit and at least one computer storage device,
an input receiving user input from an input device connected to the computer,
an output providing display data to a display connected to the computer, and
a network interface device connecting the computer to a computer network and managing communication with a server computer connected to the computer network;
wherein the computer storage device stores computer program instructions that, when executed by the processing system, configure the computer to be comprising:
an image module operative to retrieve image data for an image from the server computer, the image data including pixel data for the image and metadata indicating at least a foreground region in the image and a background region in the image, and an output to store the image data in the computer storage device;
a user interface element having an output providing display data for a user interface element to the computer storage device;
a compositing module operative to:
access the display data for the user interface element and the image data from the computer storage device,
access settings data from the computer storage device, the settings data including at least a relative z-order of the foreground region, background region and user interface element and properties of the user interface element, the properties including at least relative position data indicating how the display data for the user interface element is positioned relative to the pixel data for the image data, and
combine the pixel data from the foreground region, the pixel data from the background region of the image, and display data for the user interface element, based on at least the settings data to output a composite image to the computer storage device; and
a user interface module operative to output the composite image in a graphical interface to the output of the computer.

2. The computer of claim 1, wherein the user interface module is operative to change the z-order of the user interface element with respect to the foreground region and the background region in response to an event processed by the computer.

3. The computer of claim 2, wherein the user interface module is operative to change the properties of the user interface element in response to an event processed by the computer.

4. The computer of claim 3, wherein properties of the user interface element further comprises a scale property.

5. The computer of claim 4, wherein properties of the user interface element further comprises an opacity property.

6. The computer of claim 5, wherein properties of the user interface element further comprises a blur property.

7. The computer of claim 1, wherein the user interface module is operative to change properties of the user interface element in response to an event processed by the computer.

8. The computer of claim 7, wherein properties of the user interface element further comprises a scale property.

9. The computer of claim 8, wherein properties of the user interface element further comprises an opacity property.

10. The computer of claim 9, wherein properties of the user interface element further comprises a blur property.

11. A computer comprising:
a processing system comprising at least one processing unit and at least one computer storage device, an input receiving user input from an input device connected to the computer, and an output providing display data to a display connected to the computer;
wherein the computer storage device stores computer program instructions that, when executed by the processing system, configure the computer to be comprising:
a user interface element having an output providing display data for a user interface element to the computer storage device;
wherein the computer storage device further stores image data for an image, the image data including pixel data for the image and metadata indicating at least a foreground region in the image and a background region in the image;
a compositing module operative to:
access the display data for the user interface element and the image data from the computer storage device,
specify a user interface object in the computer storage device comprising at least a reference to the foreground region of the image data, a reference to the background region of the image data, and a reference to the user interface element, the user interface object further comprising settings data including at least a relative z-order of the foreground region, background region and user interface element and properties of the user interface element, the properties including at least relative position data indicating how the display data for the user interface element is positioned relative to the pixel data for the image data, and
combine the pixel data from the foreground region, the pixel data from the background region of the image, and display data for the user interface element, based on at least the settings data to output a composite image to the computer storage device; and
a user interface module operative to output the composite image in a graphical interface to the output of the computer.

12. The computer of claim 11, wherein the user interface module is operative to change the z-order of the user interface element with respect to the foreground region and the background region in response to an event processed by the computer.

13. The computer of claim 12, wherein the user interface module is operative to change properties of the user interface element in response to an event processed by the computer.

14. The computer of claim 13, wherein properties of the user interface element further comprises a scale property.

15. The computer of claim 14, wherein properties of the user interface element further comprises an opacity property.

16. The computer of claim 15, wherein properties of the user interface element further comprises a blur property.

17. The computer of claim 11, wherein the user interface module is operative to change properties of the user interface element in response to an event processed by the computer.

18. The computer of claim 17, wherein properties of the user interface element further comprises a scale property.

19. The computer of claim 18, wherein properties of the user interface element further comprises an opacity property.

20. The computer of claim 19, wherein properties of the user interface element further comprises a blur property.
